(19) United States
(12) Patent Application Publication
(10) Pub. No.: US 2009/0296021 A1
(43) Pub. Date: Dec. 3, 2009

(54) OPTICAL SHEET, BACKLIGHT UNIT, AND LIQUID CRYSTAL DISPLAY

(76) Inventors: Junghoon LEE, Cheongju-si (KR); Kyongrae KIM, Cheongju-si (KR)

Correspondence Address: KED & ASSOCIATES, LLP, P.O. BOX 221200, CHANTILLY, VA, 20153-1200, US

(21) Appl. No.: 12/267,883

(22) Filed: Nov. 10, 2008

(30) Foreign Application Priority Data
May 28, 2008 (KR) 10-2008-0049484

(51) Int. Cl. G02F 1/13357; G02B 5/30

(52) U.S. Cl. 349/64; 359/487

(57) ABSTRACT

An optical sheet, a backlight unit including the optical sheet, and a liquid crystal display including the backlight unit may be provided. The optical sheet may include a reflective polarizing film, a base film on one surface of the reflective polarizing film, and a projection portion on the base film. The projection portion may include a plurality of diffusion particles, a plurality of peaks, a plurality of valleys formed from the plurality of peaks, and a base portion between the base film and the peaks and the valleys. A height of the base portion is approximately 5% to 50% of a height of one of the peaks.

This application claims priority from Korean Patent Application No. 10-2008-0049484 filed May 28, 2008, the subject matter of which is incorporated herein by reference.

### BACKGROUND

1. Field

Embodiments of the invention may relate to an optical sheet, a backlight unit including the optical sheet, and/or a liquid crystal display including the backlight unit.

2. Background

A display field may visually display information of various electrical signals. In the display field, various types of flat panel displays having excellent characteristics such as thin profile, lightness in weight, and low power consumption have been introduced. Additionally, flat panel displays are replacing cathode ray tubes (CRT).

Examples of flat panel displays include a liquid crystal display (LCD), a plasma display panel (PDP), a field emission display (FED), and an electroluminescence display (ELD). The liquid crystal display may be used as a display panel of notebooks, monitors of personal computers, and/or TV monitors because of a high contrast ratio and excellent display characteristics of a moving picture.

The liquid crystal display may be considered a light receiving display. The liquid crystal display may include a liquid crystal display panel that displays an image and a backlight unit that is positioned under the liquid crystal display panel to provide the liquid crystal display panel with light.

The backlight unit may include a light source and an optical sheet. The optical sheet may include a diffusion sheet, a prism, or a protective sheet.

In the backlight unit, the optical sheet (including a plurality of sheets) may be used to diffuse and focus light produced by the light source. However, there may be many limits to improvement in fabrication yield and improvement in luminance of the backlight unit.

### BRIEF DESCRIPTION OF THE DRAWINGS

Arrangements and embodiments may be described in detail with reference to the following drawings in which like reference numerals refer to like elements and wherein:

FIGS. 1-3 show an optical sheet according to an example embodiment of the present invention;

FIGS. 4 to 8 show an optical sheet according to example embodiments of the present invention;

FIG. 9 shows an optical sheet according to an example embodiment of the present invention;

FIGS. 10 and 11 are an exploded perspective view and a cross-sectional view illustrating a configuration of a backlight unit including an optical sheet according to an example embodiment of the present invention;

FIGS. 12 and 13 are an exploded perspective view and a cross-sectional view illustrating a configuration of a backlight unit according to an example embodiment of the present invention; and

FIGS. 14 and 15 are an exploded perspective view and a cross-sectional view illustrating a configuration of a liquid crystal display according to an example embodiment of the present invention.

### DETAILED DESCRIPTION

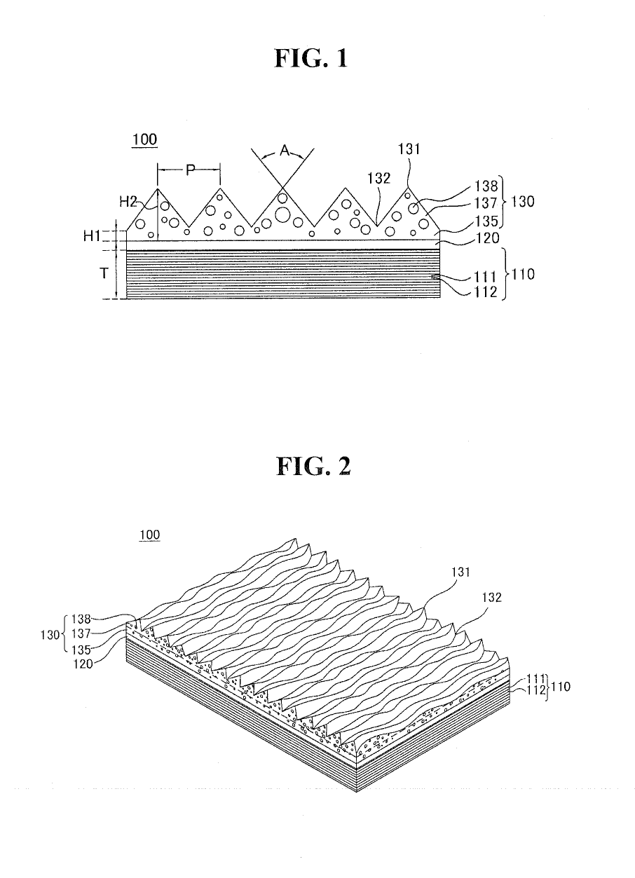

FIGS. 1 to 3 show an optical sheet according to an example embodiment of the present invention. Other embodiments and configurations are also within the scope of the present invention.

As shown in FIGS. 1 to 3, an optical sheet 100 may include a reflective polarizing film 110, a base film 120 on one surface of the reflective polarizing film 110, and a projection portion 130 on the base film 120. The projection portion 130 may include a plurality of diffusion particles 138.

The reflective polarizing film 110 may transmit or reflect light from a light source. The reflective polarizing film 110 may include a first layer 111 formed of a polymer and a second layer 112 positioned adjacent to the first layer 111. The second layer 112 may be formed of a polymer having a refractive index different from a refractive index of the polymer forming the first layer 111.

The reflective polarizing film 110 may have a structure in which the first layers 111 and the second layers 112 are alternately stacked in a repeated manner. The first layers 111 may be formed of polymethylmethacrylate (PMMA), and the second layers 112 may be formed of polyester.

The reflective polarizing film 110 may have a thickness T of approximately 100 μm to 300 μm in a small-sized display device, and may have a thickness T of approximately 700 μm to 800 μm in a large-sized display device.

A portion of the light from the light source may be transmitted by the reflective polarizing film 110, and a portion of the light from the light source may be reflected toward the light source underlying the reflective polarizing film 110. The light reflected toward the light source may be again reflected and be incident on the reflective polarizing film 110. A portion of the light incident on the reflective polarizing film 110 may be transmitted by the reflective polarizing film 110, and a portion of the light incident on the reflective polarizing film 110 may be reflected toward the light source underlying the reflective polarizing film 110.

In other words, because the reflective polarizing film 110 includes the first layers 111 and the second layers 112 alternately stacked on each other, and a refractive index of the first layer is different from a refractive index of the second layer, the reflective polarizing film 110 can improve efficiency of the light from the light source using a principle in which molecules of the polymer are oriented in one direction to transmit a polarization of a direction different from the orientation direction of the molecules and to reflect a polarization of a same direction as the orientation direction of the molecules.

The base film 120 can transmit light from the light source. The base film 120 may be formed of a light transmitting material, such as polyethylene terephthalate, polycarbonates, polypropylene, polyethylene, polystyrene, and polyepoxy, for example. Other materials may also be used.

The base film 120 may have a thickness of approximately 50 μm to 300 μm. When the thickness of the base film 120 is equal to or greater than 50 μm, a mechanical strength and a thermal stability of the base film 120 can be secured. When the thickness of the base film 120 is equal to or less than 300 μm, a flexibility of the base film 120 can be secured while a mechanical strength and a thermal stability of the base film 120 are secured.

The projection portion 130 on the base film 120 may focus and diffuse the light from the light source.

The projection portion 130 may be formed of a transparent polymer resin so as to transmit light coming from outside. Examples of the transparent polymer resin include acrylic resin, polycarbonates, polypropylene, polyethylene, and polyethylene terephthalate.

The projection portion 130 may include a plurality of triangle-shaped prisms. As shown in FIG. 1, the projection portion 130 may include a plurality of peaks 131 and a plurality of valleys 132 (formed from the peaks). The plurality of peaks 131 and the plurality of valleys 132 may be separately formed in a straight line pattern along a longitudinal direction of the projection portion 130.

A distance P between the peaks 131 may be approximately 20 μm to 60 μm, and an angle A of the peaks 131 may be approximately 70° to 110°. A height of the projection portion 130 may be approximately 10 μm to 300 μm.

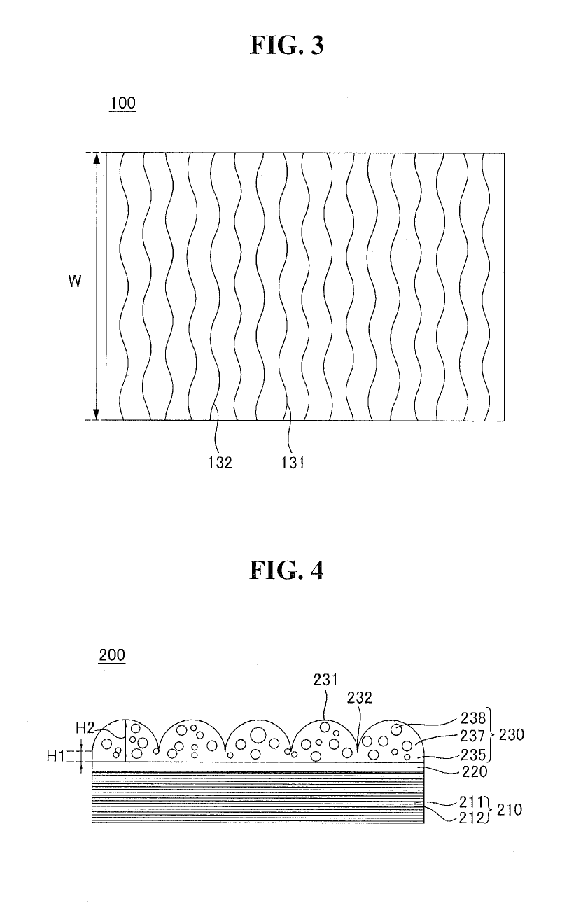

As shown in FIGS. 2 and 3, the peaks 131 and the valleys 132 may form continuous bending lines or meandering patterns along the longitudinal direction of the projection portion 130, and the continuous bending lines or meandering patterns may be uniform or non-uniform. In other words, the peaks 131 may meander in an uneven pattern (or an uneven manner) along a width W of the projection portion 130. An average horizontal amplitude of the peaks 131 may be approximately 1 μm to 20 μm. Further, the valleys 132 may meander in an uneven pattern (or an uneven manner) along the width W of the projection position 130. An average horizontal amplitude of the valleys 132 may be approximately 1 μm to 20 μm.

A height H2 of the peaks 131 may be measured from the base film 120 to one of the peaks 131 (such as a height of highest peak or an average height of the peaks). The height H2 may be different for each of the peaks 131. The peaks 131 may form uniform or non-uniform bending lines and/or meandering uneven patterns. An average difference between the heights H2 of the peaks 131 may be approximately 1 μm to 20 μm. A height H1 of the base portion 135 may be measured from the base film 120 to one of the valleys 132 as a height of lowest valley or an average height valley). The height H1 may change along the base portion 135. The valleys 132 may form uniform or non-uniform bending lines and/or meandering uneven patterns.

The projection portion 130 may include a first resin 137 and a plurality of first diffusion particles 138 (and/or a plurality of bubbles). The first resin 137 may be acrylic resin, and the first diffusion particles 138 may be first beads. The first diffusion particles 138 may be formed of polymethylmethacrylate (PMMA, polystyrene, and/or silicon.

The first resin 137 may include an antistatic agent. The antistatic agent may be formed of polyvinyl benzyl, polyacrylate (polymethacrylate), styrene acrylate (styrene methacrylate) copolymer, methacrylate methacrylamide copolymer, and the like.

The projection portion 130 may be formed of the first resin 137, and the diffusion particles 138 may be provided in the projection portion 130 in an amount of approximately 1 to 10 parts by weight based on 100 parts by weight of the first resin 137.

The following Table 1 shows diffusion characteristics and luminance characteristics of the optical sheet 100 depending on content of the diffusion particles 138 based on 100 parts by weight of the first resin 137. In the following Table 1, X, ∘, and ⊚ represent bad, good, and excellent states of the characteristics, respectively.

TABLE 1

| Content of Diffusion Particles | | |
|---|---|---|
| Based on 100 Parts by Weight of | | |
| First Resin | Diffusion | Luminance |
| (parts by weight) | Characteristics | Characteristics |
| 0.1 | X | ⊚ |
| 0.5 | X | ⊚ |
| 1 | ◯ | ⊚ |
| 2 | ◯ | ◯ |
| 3 | ◯ | ◯ |
| 5 | ◯ | ◯ |
| 7 | ◯ | ◯ |
| 9 | ◯ | ◯ |
| 10 | ⊚ | ◯ |
| 12 | ⊚ | X |
| 15 | ⊚ | X |

As indicated in the above Table 1, when content of the diffusion particles 138 based on 100 parts by weight of the first resin 137 is equal to or greater than 1 part by weight, diffusion characteristics of the light from the light source is excellent. When the content of the diffusion particles 138 based on 100 parts by weight of the first resin 137 is equal to or less than 10 parts by weight, a reduction in luminance can be prevented.

The diffusion particles 138 inside the first resin 137 may be non-uniform (and thus have different diameters).

The diffusion particles 138 may have a circle shape, an oval shape, a snowman shape, and/or an uneven circle shape. Other shapes may also be used.

The diffusion particles 138 may be non-uniformly distributed inside the first resin 137. The diffusion particles 138 can be completely distributed inside the first resin 137 so as not to expose the diffusion particles 138 from a surface of the projection portion 130. The diffusion particles 138 may be embedded inside the first resin 137 forming the projection portion 130.

The projection portion 130 may include the plurality of peaks 131 and the plurality of valleys 132 formed from the peaks 131, and may further include a base portion 135 between the base film 120 and the peaks 131 and the valleys 132. The plurality of peaks 131 extend from the base portion 135. The peaks 131, the valleys 132, and the base portion 135 may form an integral body of the projection portion 130.

A height H1 of the base portion 135 may be approximately 5% to 50% of the height H2 of one of the peaks 131.

The following Table 2 shows light transmission characteristics and a defective check of the optical sheet 100 depending on a percentage of the height H1 of the base portion 135 based on the height H2 of one of the peaks 131. In the following Table 2, X, ∘, and ⊚ in the light transmission characteristics represent bad, good, and excellent states of the characteristics, respectively. Further, in the defective check, ∘ represents that there are defects, and X represents that there are no defects.

TABLE 2

| Percentage of Height of Base | | |
|---|---|---|
| Portion Based on Height of | Light Transmission | |
| Peak (%) | Characteristics | Defective Check |
| 1 | ⊚ | ◯ |
| 3 | ⊚ | ◯ |
| 5 | ⊚ | X |
| 10 | ◯ | X |
| 20 | ◯ | X |
| 30 | ◯ | X |
| 40 | ◯ | X |
| 50 | ◯ | X |
| 60 | X | X |
| 70 | X | X |
| 80 | X | X |

As shown in FIG. 2, when the height H1 of the base portion 135 is equal to or greater than 5% of the height H2 of one of the peaks 131, the base film 120 can be prevented from being damaged by pressure in fabrication of the projection portion 130. When the height H1 of the base portion 135 is equal to or less than 50% of the height H2 of one of the peaks 131, a reduction in transmittance of the light from the light source resulting from the thick base portion 135 can be prevented.

Accordingly, the height H1 of the base portion 135 may be approximately 0.1 μm to 20 μm.

As described above, the optical sheet 100 may improve efficiency of the light from the light source by the projection portion 130 on the reflective polarizing film 110. The optical sheet 100 may focus efficiency on an emission surface of the projection portion 130 by including the diffusion particles 138 inside the projection portion 130.

FIGS. 4 to 8 show an optical sheet according to example embodiments of the present invention. Other embodiments and configurations are also within the scope of the present invention.

As shown in FIG. 4, an optical sheet 200 may include a reflective polarizing film 210, a base film 220 on one surface of the reflective polarizing film 210, and a projection portion 230 on the base film 220. The projection portion 230 may include a plurality of first diffusion particles 238 (and/or a plurality of bubbles).

Since configurations of the reflective polarizing film 210 and the base film 220 are similar or the same as shown in FIGS. 1 to 3, a further description thereof may be omitted.

The projection portion 230 may be formed of a transparent polymer resin to transmit light coming from outside. Examples of the transparent polymer resin may include acrylic resin, polycarbonates, polypropylene, polyethylene, and polyethylene terephthalate.

The projection portion 230 may include a first resin 237 and the plurality of first diffusion particles 238 (and/or a plurality of bubbles). The first resin 237 may be acrylic resin, and the first diffusion particles 238 may be first beads. The first diffusion particles 238 may be formed of polymethylmethacrylate (PMMA), polystyrene, and/or silicon.

The projection portion 230 may include 1 to 10 parts by weight of the diffusion particles 238 based on 100 parts by weight of the first resin 237. Diameters of the diffusion particles 238 inside the first resin 237 may be non-uniform (i.e., the diameters may vary).

The diffusion particles 238 may have a circle shape, an oval shape, a snowman shape, and/or an uneven circle shape. Other shapes may also be used.

The diffusion particles 238 may be non-uniformly distributed inside the first resin 237. The diffusion particles 238 may be completely distributed inside the first resin 237 so as not to expose the diffusion particles 238 from the surface of the projection portion 230. The diffusion particles 238 may be embedded inside the first resin 237 forming the projection portion 230.

The projection portion 230 may include a plurality of peaks 231 and a plurality of valleys 232 formed from the plurality of peaks 231. The projection portion 230 may further include a base portion 235 between the base film 210 and the peaks 231 and the valleys 232. The plurality of peaks 231 extend from the base portion 235. The peaks 231, the valleys 232, and the base portion 235 may form an integral body of the projection portion 230.

A height H1 of the base portion 235 may be approximately 5% to 50% of a height H2 of one of the peaks 231. A height H1 of the base portion 235 may be a distance from the base film 220 to a lowest one of the valleys 232. A height H2 of the peaks 231 may be a distance from the base film 220 to one of the peaks 231 (such as a highest peak or an average height of the peaks).

When the height H1 of the base portion 235 is equal to or greater than 5% of the height H2 of one of the peaks 231, the base film 220 may be prevented from being damaged by pressure in fabrication of the projection portion 230. When the height H1 of the base portion 235 is equal to or less than 50% of the height H2 of one of the peaks 231, a reduction in transmittance of the light from a light source resulting from the thick base portion 235 can be prevented.

Accordingly, the height H1 of the base portion 235 may be approximately 0.1 μm to 20 μm.

The projection portion 230 may include a plurality of microlenses or a plurality of lenticular lenses.

As shown in FIGS. 4 to 6, the microlenses may have an embossed form of a hemispherical share on one surface of the base film 220.

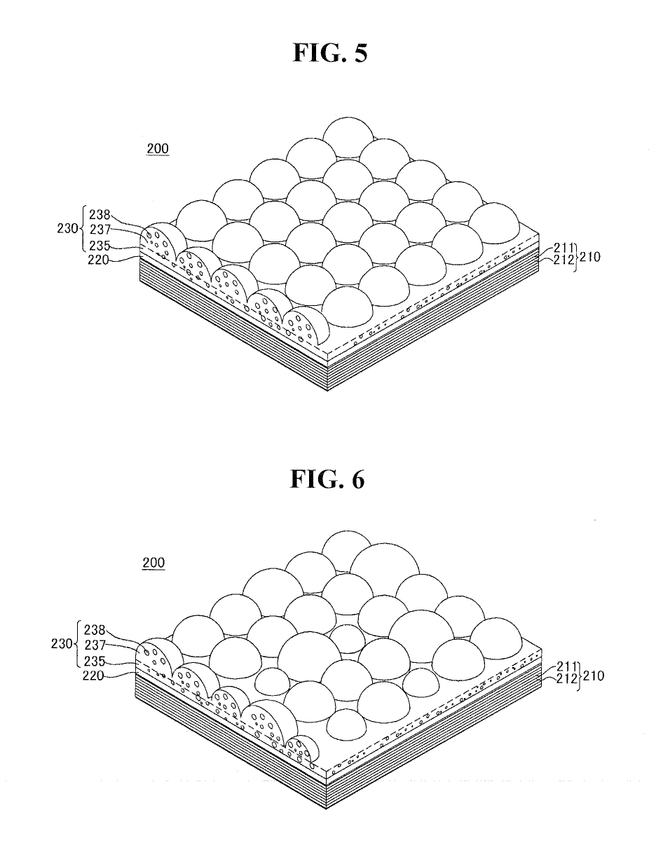

A diffusivity, a refractive index, a focusing level, etc. of the microlens may change depending on a pitch and a density of the microlens. Diameters of the microlenses may be uniform as shown in FIG. 5, or diameters of the microlens may be non-uniform as shown in FIG. 6. Heights of the microlenses may be uniform or non-uniform.

The diameter of each of the microlenses may be approximately 20 μm to 200 μm. The microlenses may occupy 50% to 90% of a whole area of the projection portion 230. Other diameters and percentages may also be used.

As described above, since the microlenses have the embossed form of a hemispherical shape, a portion of light coming the outside, (e.g., from a bottom of the microlens) may be uniformly refracted and condensed from the hemispherical surface. Because of this, a portion of light from the bottom of the microlens can be uniformly diffused upward and can be focused.

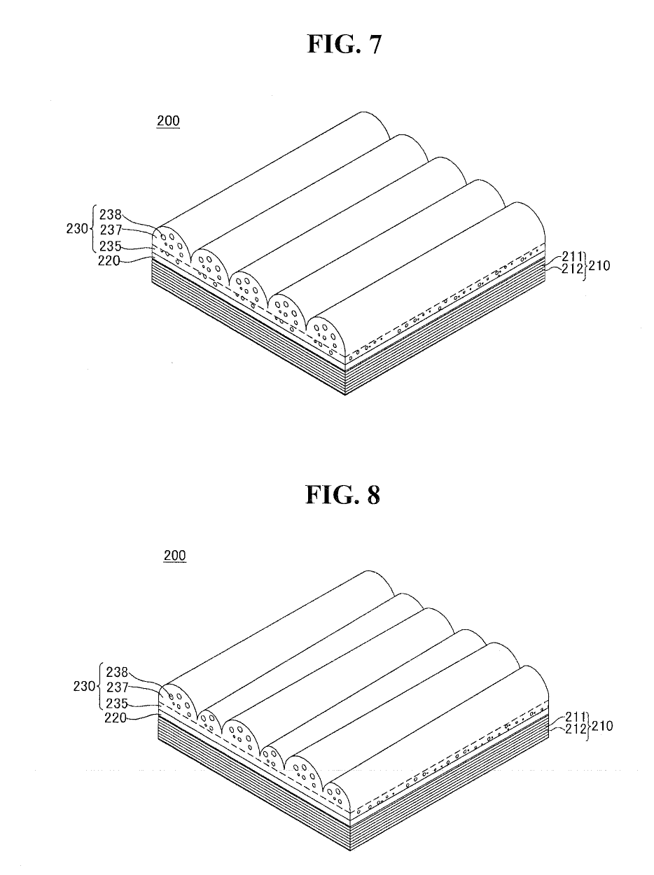

As shown in FIGS. 7 and 8, the projection portion 230 may include a plurality of lenticular lenses. The lenticular lenses may each have a hemispherical shaped section. The lenticular lenses may continuously extend in a longitudinal direction, unlike the embossed pattern of the microlens. For example, the lenticular lenses may have a tunnel form.

Pitches of the lenticular lenses may be uniform as shown in FIG. 7, or pitches of the lenticular lenses may be non-uniform as shown in FIG. 8. Heights of the lenticular lenses may be uniform or non-uniform.

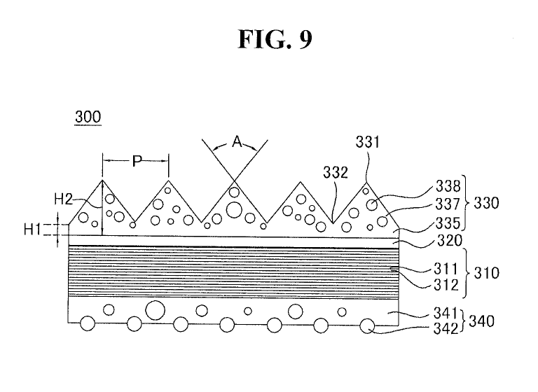

FIG. 9 shows an optical sheet according to an example embodiment of the present invention. Other embodiments and configurations are also within the scope of the present invention.

As shown in FIG. 9, an optical sheet 300 may include a reflective polarizing film 310, a base film 320 on the reflective polarizing film 310, a projection portion 330 on the base film 320, and a protective layer 340 under the reflective polarizing film 310.

The reflective polarizing film 310 can transmit or reflect light from a light source. The reflective polarizing film 310 may include a first layer 311 formed of a polymer and a second layer 312 positioned adjacent to the first layer 311. The second layer 312 may be formed of a polymer having a refractive index different from a refractive index of the polymer forming the first layer 311.

The reflective polarizing film 310 may have a structure in which the first layers 311 and the second layers 312 are alternately stacked in a repeated manner. The first layers 311 may be formed of polymethylmethacrylate (PMMA), and the second layers 312 may be formed of polyester.

The base film 320 can transmit light from the light source. The base film 320 may be formed of a light transmitting material, such as polyethylene terephthalate, polycarbonates, polypropylene, polyethylene, polystyrene, and polyepoxy, for example.

The base film 320 may have a thickness of approximately 50 μm to 300 μm. When the thickness of the base film 320 is equal to or greater than 50 μm, a mechanical strength and a thermal stability of the base film 320 can be secured. When the thickness of the base film 320 is equal to or less than 300 μm, flexibility of the base film 320 can be secured while a mechanical strength and a thermal stability of the base film 320 are secured.

The projection portion 330 may be formed of a transparent polymer resin to transmit light coming from the outside. Examples of the transparent polymer resin may include acrylic resin, polycarbonates, polypropylene, polyethylene, and polyethylene terephthalate.

The projection portion 330 may include one of a prism, a microlens, and a lenticular lens.

The projection portion 330 may include a plurality of peaks 331 and a plurality of valleys 332 formed from the peaks 331, and may further include a base portion 335 between the base film 320 and the peaks 331 and the valleys 332. The plurality of peaks 331 extend from the base portion 335. A height H1 of the base portion 335 may be a distance from the base film 320 to one of the valleys 332 (such as a height of lowest valley or an average height of valley). A height H2 of the peaks 331 may be a distance from the base film 320 to one of the peaks 331 (such as a highest peak or an average height of the peaks).

The projection portion 330 may include a first resin 337 and a plurality of diffusion particles 338 (and/or a plurality of bubbles). The first resin 337 may be acrylic resin, and the diffusion particles 338 may be first beads. The diffusion particles 338 may be formed using polymethylmethacrylate (PMMA), polystyrene, and/or silicon.

The projection portion 330 may include 1 to 10 parts by weight of the diffusion particles 338 based on 100 parts by weight of the first resin 337. Diameters of the diffusion particles 338 inside the first resin 337 may be non-uniform (i.e., the diameters may vary).

The diffusion particles 338 may have a circle shape, an oval shape, a snowman shape, and/or an uneven circle shape. Other shapes may also be used.

The diffusion particles 338 may be non-uniformly distributed inside the first resin 337. The diffusion particles 338 may be completely distributed inside the first resin 337 so as not to expose the diffusion particles 338 from a surface of the projection portion 330. The diffusion particles 338 may be embedded inside the first resin 337 forming the projection portion 330.

The protective layer 340 can improve thermal resistance of the optical sheet 300. The protective layer 340 may include a second resin 341 and a plurality of beads 342 distributed inside the second resin 341.

The second resin 341 may be transparent acrylic resin whose thermal resistance and mechanical characteristics are excellent. The second resin 341 may be the same as or similar to the first resin. The second resin 341 may include an antistatic agent. The antistatic agent may be formed of polyvinyl benzyl, polyacrylate (polymethacrylate), styrene acrylate (styrene methacrylate) copolymer, methacrylate methacrylamide copolymer, and the like.

The beads 342 may be formed using the same material as the second resin 341 or using a material different from the second resin 341. The protective layer 340 may include a portion formed of the second resin 341, and the beads 342 may be provided in the protective layer 340 in an amount of approximately 10 to 50 parts by weight based on 100 parts by weight of the second resin 341.

The size of the beads 342 may be properly selected depending on a thickness of the reflective polarizing film 310, and may be approximately 2 μm to 10 μm.

The size of the beads 342 may be substantially equal to each other and may be uniformly distributed inside the second resin 341. The size of the beads 342 may be different from each other and may be non-uniformly distributed inside the second resin 341. The beads 342 may be embedded inside the second resin 341 forming the protective layer 340. A portion of the beads 342 may be exposed outside the second resin 341 forming the protective layer 340. That is, at least one of the beads 342 may protrude from the protective layer 340.

The beads 342 may be formed using the same material as the first beads or using a material different from the first beads.

The protective layer 340 may prevent the optical sheet 400 from being deformed by light from the light source. The second resin 341 having an excellent thermal resistance can prevent the optical sheet 400 from crumpling. Even if the optical sheet 400 is deformed at a high temperature, the optical sheet 400 can be restored to its original state at a normal temperature. The protective layer 340 can prevent generation of a flaw on the optical sheet 400 caused by an external impact or mechanical force. The protective layer 340 can improve uniformity of luminance by diffusing light from the light source using the beads 342.

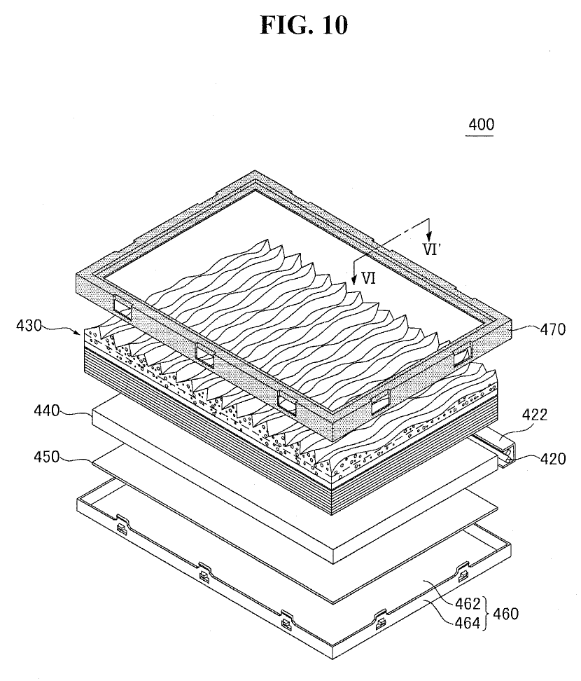

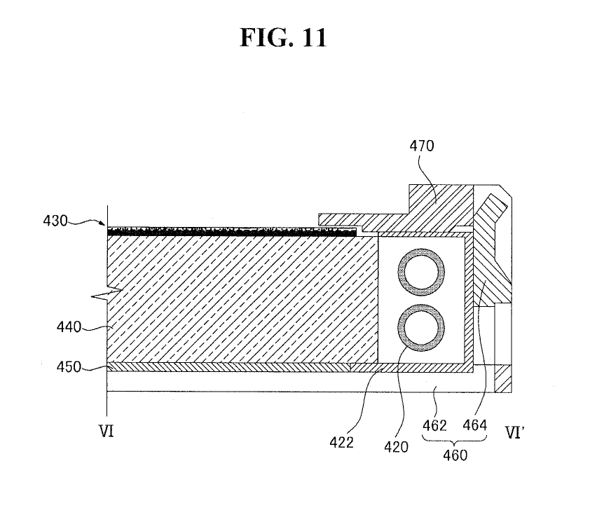

FIGS. 10 and 11 are an exploded perspective view and a cross-sectional view illustrating a configuration of a backlight unit including an optical sheet according to an example embodiment of the present invention. Other embodiments and configurations are also within the scope of the present invention.

FIG. 10 shows an edge type backlight unit. Since configuration of an optical sheet shown in FIGS. 10 and 11 is substantially the same as the optical sheets described above. Further, a description may be briefly made or may be entirely omitted.

As shown in FIGS. 10 and 11, a backlight unit 400 may be included in a liquid crystal display and may provide light to a liquid crystal display panel included in the liquid crystal display.

The backlight unit 400 may include a light source 420 and an optical sheet 430. The backlight unit 400 may further include a light guide 440, a reflector 450 (or reflector plate), a bottom cover 460, and a mold frame 470.

The light source 420 may produce light using a drive power received from outside the light source and may emit the produced light.

The light source 420 may be positioned at one side of the light guide 440 along a long axis direction of the light guide 440. The light source 420 may be positioned at both sides of the light guide 440. Light from the light source 420 may be directly incident on the light guide 440. Alternatively, the light from the light source 420 may be reflected from a light source housing 422 surrounding a portion of the light source 420, for example, surrounding about ¾ of an outer circumferential surface of the light source 420, and then the light may be incident on the light guide 440.

The light source 420 may be one of a cold cathode fluorescent lamp (CCFL), a hot cathode fluorescent lamp (HCFL), an external electrode fluorescent lamp (EEFL), and a light emitting diode (LED). Other light sources may also be used.

The optical sheet 430 may be positioned on the light guide 440. The optical sheet 430 can focus the light from the light source 420.

The optical sheet 430 may include a reflective polarizing film, a base film on one surface of the reflective polarizing film, and a projection portion on the base film. The projection portion may include a plurality of diffusion particles, a plurality of peaks, a plurality of valleys formed from the plurality of peaks, and a base portion between the base film and the peaks and the valleys. A height of the base portion may be approximately 5% to 50% of a height of one of the peaks.

If light coming from the light source 420 under the optical sheet 430 is incident on the optical sheet 430, the incident light may be reflected or transmitted by the reflective polarizing film. The efficiency of the light from the light source 420 can be improved. The diffusion particles of the projection portion may diffuse the light transmitted by the reflective polarizing film to provide a uniform luminance. As a result, display quality of the backlight unit 400 can be improved.

The light guide 440 may face the light source 420. The light guide 440 may guide the light so as to emit the light from the light source 420 in an upward manner.

The reflector 450 may be positioned under the light guide 440. The reflector 450 can reflect the light upward. The light may come from the light source 420 and then is emitted downward via the light guide 440.

The bottom cover 460 may include a bottom portion 462 and a side portion 464 extending from the bottom portion 462 to form a recipient space. The recipient space may receive the light source 420, the optical sheet 430, the light guide 440, and the reflector 450.

The mold frame 470 may be approximately a rectangular-shaped frame. The mold frame 470 may be fastened to the bottom cover 460 from an upper side of the bottom cover 460 in a top-down manner.

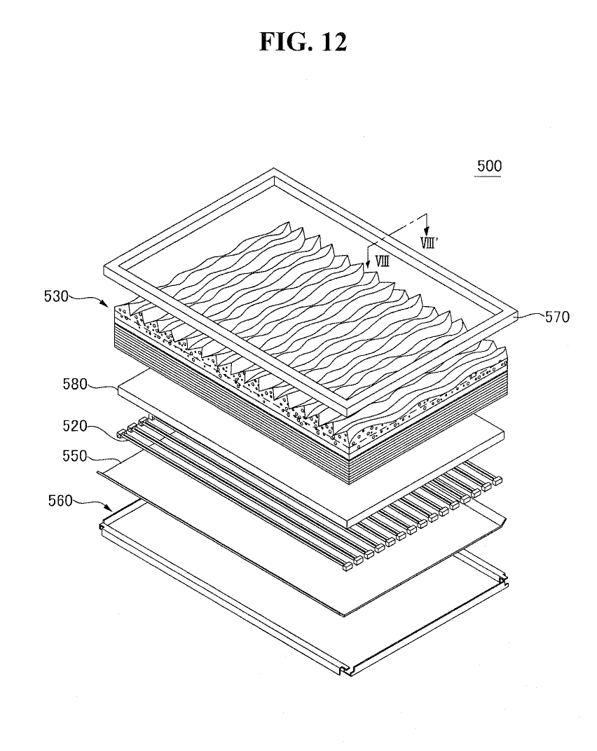

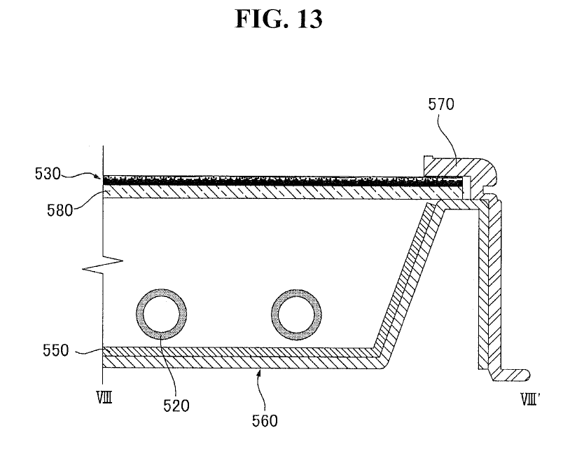

FIGS. 12 and 13 are an exploded perspective view and a cross-sectional view illustrating a configuration of a backlight unit according to an example embodiment of the present invention. Other embodiments and configurations are also within the scope of the present invention.

FIGS. 12 and 13 show a direct type backlight unit. Since a backlight unit 500 shown in FIGS. 12 and 13 may be substantially the same as the backlight unit shown in FIGS. 10 and 11 (except a location of a light source and changes in components depending on location of the light source), a further description may be briefly made or may be entirely omitted.

As shown in FIGS. 12 and 13, the backlight unit 500 may be included in a liquid crystal display and may provide light to a liquid crystal display panel included in the liquid crystal display.

The backlight unit 500 may include a light source 520 and an optical sheet 530. The backlight unit 500 may further include a reflector 550 (or reflector plate), a bottom cover 560, a mold frame 570, and a diffusion plate 580 (or diffuser).

The light source 520 may be positioned under the diffusion plate 580. Therefore, light from the light source 520 can be directly incident on the diffusion plate 580.

The optical sheet 530 may be positioned on the diffusion plate 580. The optical sheet 530 may focus the light from the light source 520.

The optical sheet 530 may include a reflective polarizing film, a base film on one surface of the reflective polarizing film, and a projection portion on the base film. The projection portion may include a plurality of diffusion particles, a plurality of peaks, a plurality of valleys formed from the plurality of peaks, and a base portion between the base film and the peaks and the valleys. A height of the base portion may be approximately 5% to 50% of a height of one of the peaks.

If light coming from the light source 520 under the optical sheet 530 is incident on the optical sheet 530, the incident light may be reflected or transmitted by the reflective polarizing film. The efficiency of the light from the light source 520 can be improved. The diffusion particles of the projection portion may diffuse the light transmitted by the reflective polarizing film to provide a uniform luminance. As a result, display quality of the backlight unit 500 can be improved.

The diffusion plate 580 may be positioned between the light source 520 and the optical sheet 530 and can diffuse the light coming upward from the light source 520. A shape of the light source 520 may not be seen from a top of the backlight unit 500 because of the diffusion plate 580 on the light source 520. The diffusion plate 580 may further diffuse the light coming from the light source 520.

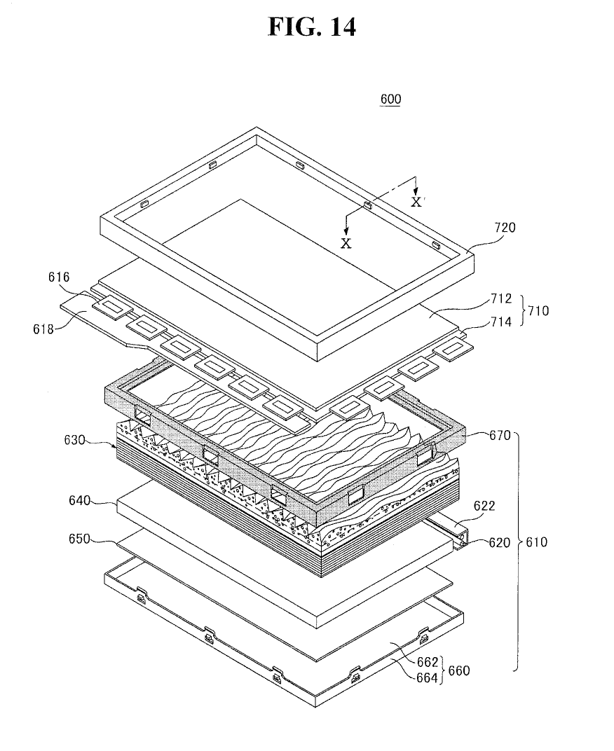

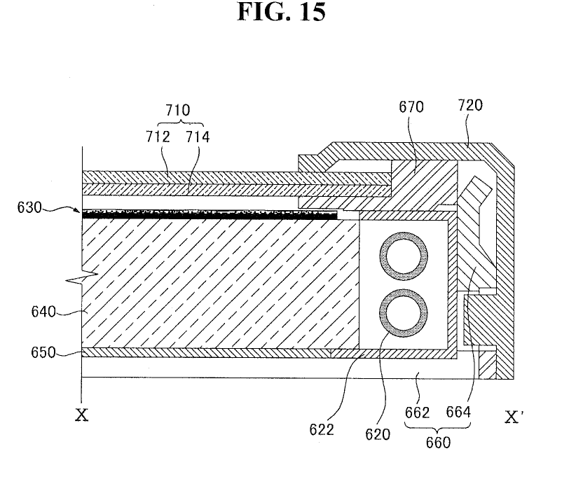

FIGS. 14 and 15 are an exploded perspective view and a cross-sectional view illustrating a configuration of a liquid crystal display according to an example embodiment of the present invention. Other embodiments and configurations are also within the scope of the present invention.

A liquid crystal display 600 shown in FIGS. 14 and 15 may include the backlight unit shown in FIGS. 10 and 11. For example, the liquid crystal display 600 may include a backlight unit shown 610 similar to the backlight unit in FIGS. 12 and 13. Since the backlight unit 610 shown in FIGS. 14 and 15 is described above with reference to FIGS. 10 and 11, a further description thereof will be briefly made or will be entirely omitted.

As shown in FIGS. 14 and 15, the liquid crystal display 600 can display an image using electro-optical characteristics of liquid crystals.

The liquid crystal display 600 may include the backlight unit 610 and a liquid crystal display panel 710. The backlight unit 610 may be positioned under the liquid crystal display panel 710 and may provide light to the liquid crystal display panel 710.

The backlight unit 610 may include a light source 620 and an optical sheet 630. Light from the light source 620 may be reflected from a light source housing 622. The backlight unit 610 may further include a light guide 640 (or light guide plate), a reflector 650 (or reflector plate), a bottom cover 660, and a mold frame 670.

The liquid crystal display panel 710 may be positioned on the mold frame 670. The liquid crystal display panel 710 may be fixed by a top cover 720 that is fastened to the bottom cover 660 in a top-down manner. The bottom cover 660 may include a bottom portion 662 and a side portion 664 extending from the bottom portion to form a recipient space.

The liquid crystal display panel 710 may display an image using light provided by the light source 620 of the backlight unit 610.

The liquid crystal display panel 710 may include a color filter substrate 712 and a thin film transistor substrate 714 that are opposite to each other with liquid crystals interposed between the color filter substrate 712 and the thin film transistor substrate 714.

The color filter substrate 712 may achieve colors of an image displayed on the liquid crystal display panel 710.

The color filter substrate 712 may include a color filter array of a thin film form on a substrate made of a transparent material such as glass or plastic. For example, the color filter substrate 712 may include red, green, and blue color filters. An upper polarizing plate may be positioned on the color filter substrate 712.

The thin film transistor substrate 714 may be electrically connected to a printed circuit board 618, on which a plurality of circuit parts are mounted, through a drive film 616. The thin film transistor substrate 714 may apply a drive voltage provided by the printed circuit board 618 to liquid crystals in response to a drive signal provided by the printed circuit board 618.

The thin film transistor substrate 714 may include a thin film transistor and a pixel electrode on another substrate made of a transparent material such as glass or plastic. A lower polarizing plate may be positioned under the thin film transistor substrate 714.

The optical sheet, the backlight unit including the optical sheet, and the liquid crystal display including the backlight unit according to the example embodiments of the invention may provide uniform luminance by forming the projection portion including diffusion particles on the reflective polarizing film, thereby improving display quality.

An example embodiment of the present invention may provide an optical sheet, a backlight unit including the optical sheet, and/or a liquid crystal display including the backlight unit to improve diffusion characteristics and achieve a uniform luminance.

An optical sheet may include a reflective polarizing film, a base film on one surface of the reflective polarizing film, and a projection on the base film. The projection may include a plurality of diffusion particles, a plurality of peaks, a plurality of valleys, and a base portion under the peaks and the valleys. A height of the base portion may be approximately 5% to 50% of a height of one of the peaks.

A backlight unit may include a light source, and an optical sheet on the light source. The optical sheet may include a reflective polarizing film, a base film on one surface of the reflective polarizing film, and a projection on the base film. The projection may include a plurality of diffusion particles, a plurality of peaks, a plurality of valleys and a base portion under the peaks and the valleys. A height of the base portion may be approximately 5% to 50% of a height of one of the peaks.

A liquid crystal display may include a light source, an optical sheet on the light source, and a liquid crystal display panel on the optical sheet. The optical sheet may include a reflective polarizing film, a base film on one surface of the reflective polarizing film, and a projection on the base film. The projection may include a plurality of diffusion particles, a plurality of peaks, a plurality of valleys and a base portion under the peaks and the valleys. A height of the base portion may be approximately 5% to 50% of a height of one of the peaks.

An optical sheet may include a reflective polarizing film, a base film on one surface of the reflective polarizing film, and a projection portion on the base film. The projection portion may include a plurality of peaks that extend from the base portion, and a plurality of valleys formed from the peaks. The base portion is between the base film and the peaks and the valleys. The projection portion may include a plurality of diffusion particles. A height of the base portion may be approximately 5% to 50% of a height of one of the peaks of the plurality of peaks.

The diffusion particles may include a plurality of beads.

The projection portion may be formed of a resin, and the beads may be provided in the projection portion in an amount of approximately 1 to 10 parts by weight based on 100 parts by weight of the resin. The resin may include an antistatic agent.

At least one of the peak and the valley may meander across a width of the projection portion. A height of at least one of the peaks may vary along a longitudinal direction of the projection.

The reflective polarizing film may include a first layer and a second layer, and a refractive index of the first layer may be different from a refractive index of the second layer.

The optical sheet may further include a protective layer on another surface of the reflective polarizing film. The protective layer may be formed of a resin and beads. The beads may be provided in an amount of approximately 10 to 50 parts by weight based on 100 parts by weight of the resin. The resin may include an antistatic agent.

The projection portion may include at least one of a prism, a microlens, and a lenticular lens.

The diffusion particles may have different diameters ranging from approximately 1 μm to 10 μm.

The peaks, the valleys, and the base portion may form an integral body of the projection portion.

A thickness of the base film may be approximately 50 μm to 300 μm.

A backlight unit may include a light source, and an optical sheet on the light source. The optical sheet may include a reflective polarizing film, a base film on one surface of the reflective polarizing film, and a projection portion on the base film. The projection portion may include a plurality of diffusion particles, a plurality of peaks, a plurality of valleys and a base portion under the peaks and the valleys, wherein a height of the base portion is approximately 5% to 50% of a height of one of the peaks.

A liquid crystal display may include a light source, an optical sheet on the light source, and a liquid crystal display panel on the optical sheet. The optical sheet may include a reflective polarizing film, a base film on one surface of the reflective polarizing film, and a projection portion on the base film. The projection portion may include a plurality of diffusion particles, a plurality of peaks, a plurality of valleys and a base portion under the peaks and the valleys. A height of the base portion may be approximately 5% to 50% of a height of one of the peaks.

Any reference in this specification to “one embodiment” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An optical sheet comprising:
a reflective polarizing film;
a base film on one surface of the reflective polarizing film; and
a projection portion on the base film, the projection portion including a base portion, a plurality of peaks that extend from the base portion, and a plurality of valleys formed from the peaks, wherein the base portion is between the base film and the peaks and the valleys, and the projection portion includes a plurality of diffusion particles,
wherein a height of the base portion is a distance between the base film and one of the valleys of the plurality of valleys, and a height of one of the peaks is a distance between the base film and one of the peaks of the plurality of peaks,
wherein the height of the base portion is approximately 5% to 50% of the height of the one of the peaks of the plurality of peaks.

2. The optical sheet of claim 1, wherein the diffusion particles include a plurality of beads.

3. The optical sheet of claim 2, wherein the projection portion is formed of a resin, and wherein the beads are provided in the projection portion in an amount of approximately 1 to 10 parts by weight based on 100 parts by weight of the resin.

4. The optical sheet of claim 3, wherein the resin includes an antistatic agent.

5. The optical sheet of claim 1, wherein at least one of the peaks and the valleys meanders in an uneven pattern along a width of the projection portion.

6. The optical sheet of claim 1, wherein a height of at least one of the peaks varies along a longitudinal direction of the projection portion.

7. The optical sheet of claim 1, wherein the reflective polarizing film includes a first layer and a second layer, and wherein a refractive index of the first layer is different from a refractive index of the second layer.

8. The optical sheet of claim 1, further comprising a protective layer on another surface of the reflective polarizing film.

9. The optical sheet of claim 8, wherein the protective layer is formed of a resin and beads, and wherein the beads are provided in the protective layer in an amount of approximately 10 to 50 parts by weight based on 100 parts by weight of the resin.

10. The optical sheet of claim 9, wherein at least one of the beads protrudes from the protective layer.

11. The optical sheet of claim 9, wherein the resin includes an antistatic agent.

12. The optical sheet of claim 1, wherein the projection portion includes at least one of a prism, a microlens, and a lenticular lens.

13. The optical sheet of claim 1, wherein the diffusion particles have different diameters ranging from approximately 1 μm to 10 μm.

14. The optical sheet of claim 1, wherein the peaks, the valleys, and the base portion form an integral body of the projection portion.

15. The optical sheet of claim 1, wherein a thickness of the base film is approximately 50 μm to 300 μm.

16. The optical sheet of claim 1, wherein the optical sheet is provided in a backlight unit, and the optical sheet receives light from a light source of the backlight unit.

17. The optical sheet of claim 1, wherein the optical sheet is provided in a liquid crystal display, and the optical sheet receives light from a light source of the liquid crystal display.

18. A backlight unit comprising:
a light source; and
an optical sheet to receive light from the light source, the optical sheet including:
a reflective polarizing film,
a base film on one surface of the reflective polarizing film, and
a projection portion on the base film, the projection portion including a base portion, a plurality of peaks that extend from the base portion, and a plurality of valleys formed from the peaks, wherein the base portion is between the base film and the peaks and the valleys, and the projection portion includes a plurality of diffusion particles,
wherein a height of the base portion is a distance between the base film and one of the valleys of the plurality of valleys, and a height of one of the peaks is a distance between the base film and one of the peaks of the plurality of peaks,
wherein the height of the base portion is approximately 5% to 50% of the height of the one of the peaks of the plurality of peaks.

19. A liquid crystal display comprising:
a light source;
an optical sheet to receive light from the light source, the optical sheet including:
a reflective polarizing film,
a base film on one surface of the reflective polarizing film, and
a projection portion on the base film, the projection portion including a base portion, a plurality of peaks that extend from the base portion, and a plurality of valleys formed from the peaks, wherein the base portion is between the base film and the peaks and the valleys, and the projection portion includes a plurality of diffusion particles,
wherein a height of the base portion is a distance between the base film and one of the valleys of the plurality of valleys, and a height of one of the peaks is a distance between the base film and one of the peaks of the plurality of peaks,
wherein the height of the base portion is approximately 5% to 50% of the height of the one of the peaks of the plurality of peaks; and
a liquid crystal display panel on the optical sheet.
